(19) United States
(12) Patent Application Publication
(10) Pub. No.: US 2021/0335267 A1
(43) Pub. Date: Oct. 28, 2021

(54) DRIVING CIRCUIT AND DRIVING METHOD OF DISPLAY PANEL

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Shimin Ge, Shenzhen, Guangdong (CN)

(21) Appl. No.: 16/624,219

(22) PCT Filed: Dec. 4, 2019
(86) PCT No.: PCT/CN2019/122927

§ 371 Date: Dec. 18, 2019

(30) Foreign Application Priority Data
Nov. 14, 2019 (CN) 201911109851.9

(51) Int. Cl. G09G 3/3266; G09G 3/3275

(52) U.S. Cl. CPC G09G 3/3266; G09G 2310/08; G09G 3/3275

(57) ABSTRACT

A driving circuit and a driving method of a display panel are provided. The driving circuit includes scan lines, data lines, a driving circuit unit, and a light emitting diode. The driving circuit unit includes a first driving circuit unit and a second driving circuit unit. The first driving circuit unit and the second driving circuit unit are periodically and alternately driven to operate to power the light emitting diode. This solves issues of self-heating and low stability of thin film transistors and improves a display performance of the display panel.

### CROSS-REFERENCE TO RELATED APPLICATION

This application is the National Phase under 35 U.S.C. § 371 of International Application No. PCT/CN2019/122927, filed Dec. 4, 2019, which claims the benefit of and priority to Chinese Application No. 201911109851.9 filed on Nov. 14, 2019 and titled “DRIVING CIRCUIT AND DRIVING METHOD OF DISPLAY PANEL”, which is incorporated herein by reference in its entirety.

### FIELD OF INVENTION

The present disclosure relates to the field of display technologies, and more particularly to a driving circuit and a driving method of a display panel.

### BACKGROUND OF INVENTION

Liquid crystal display (LCD) panels have been widely used in various fields due to their lightness and thinness and low power consumption.

Micro light emitting diodes are used in backlights of LCDs, which can significantly increase brightness, color gamut, and contrast of LCDs, and improve display performance of LCDs. When driving micro light emitting diodes, the most widely used current driving methods are usually fractional active driving, which has a lower cost. An active driving circuit often drives a thin film transistor (TFT) first. However, during a driving process, a working current of the TFT is usually maintained at a certain high working current. If a TFT device continues to operate under high current, electrical properties of the TFT and other devices will deteriorate significantly due to accumulation of thermal effects. This affects working stability of the thin film transistor, causes attenuation of brightness, and further affects a display performance of a display panel.

Therefore, solutions to issues in the prior art are needed.

### SUMMARY OF INVENTION

The present disclosure provides a driving circuit and a driving method of a display panel, so as to solve issues that when a driving circuit in a conventional display panel is driven, driving current in a TFT device is too large, and a device such as a TFT is likely to generate heat, which reduces stability of the device, and display quality and display effect are not ideal.

To solve the above technical problems, technical solutions provided by embodiments of the present disclosure are as follows.

According to a first aspect of an embodiment of the present disclosure, a driving circuit of a display panel is provided, comprising: scan lines; data lines; a driving circuit unit, wherein the scan lines and the data lines are connected to the driving circuit unit, and the driving circuit unit comprises a first driving circuit unit and a second driving circuit unit; and a light emitting diode, wherein a cathode of the light emitting diode is electrically connected to the driving circuit unit, and an anode of the light emitting diode is connected to a power supply voltage; wherein when the driving circuit unit is driven, the first driving circuit unit and the second driving circuit unit are periodically and alternately driven to operate to power the light emitting diode; wherein a driving cycle of the first driving circuit unit is the same as that of the second driving circuit unit, and each of the driving cycles is 10 ms.

In an embodiment of the present disclosure, the first driving circuit unit comprises a first capacitor, a first thin film transistor (T1), and a second thin film transistor (T2), and the second driving circuit unit comprises a second capacitor, a third thin film transistor (T3), and a fourth thin film transistor (T4); wherein a gate of the first thin film transistor (T1) is electrically connected to first scan lines, a source thereof is electrically connected to the data lines, a drain thereof is electrically connected to a gate of the second thin film transistor (T2) and an end of the first capacitor, and another end of the first capacitor is grounded; wherein the gate of the second thin film transistor (T2) is electrically connected to the drain of the first thin film transistor (T1), a source thereof is grounded, and a drain thereof is electrically connected to a cathode of an organic light emitting diode and a drain of the third thin film transistor (T3); wherein a gate of the third thin film transistor (T3) is electrically connected to a drain of the fourth thin film transistor (T4) and an end of the second capacitor, the drain thereof is electrically connected to the drain of the second thin film transistor (T2) and the cathode of the organic light emitting diode, a source thereof is grounded, and another end of the second capacitor is grounded; and wherein a gate of the fourth thin film transistor (T4) is electrically connected to second scan lines, a source thereof is electrically connected to the data lines, and the drain thereof is electrically connected to the gate of the third thin film transistor (T3) and an end of the second capacitor.

In an embodiment of the present disclosure, a capacitance value of the first capacitor is the same as a capacitance value of the second capacitor.

In an embodiment of the present disclosure, the first thin film transistor (T1), the second thin film transistor (T2), the third thin film transistor (T3), and the fourth thin film transistors (T4) are all N-type thin film transistors.

In an embodiment of the present disclosure, the first thin film transistor (T1), the second thin film transistor (T2), the third thin film transistor (T3), and the fourth thin film transistor (T4) each comprise an oxide thin film transistor or an amorphous silicon thin film transistor.

In an embodiment of the present disclosure, the first thin film transistor (T1), the second thin film transistor (T2), the third thin film transistor (T3), and the fourth thin film transistors (T4) are all top-gate thin film transistors.

According to a second aspect of an embodiment of the present disclosure, a driving circuit of a display panel is provided, comprising: scan lines; data lines; a driving circuit unit, wherein the scan lines and the data lines are connected to the driving circuit unit, and the driving circuit unit comprises a first driving circuit unit and a second driving circuit unit; and a light emitting diode, wherein a cathode of the light emitting diode is electrically connected to the driving circuit unit, and an anode of the light emitting diode is connected to a power supply voltage; wherein when the driving circuit unit is driven, the first driving circuit unit and the second driving circuit unit are periodically and alternately driven to operate to power the light emitting diode.

In an embodiment of the present disclosure, the first driving circuit unit comprises a first capacitor, a first thin film transistor (T1), and a second thin film transistor (T2), and the second driving circuit unit comprises a second capacitor, a third thin film transistor (T3), and a fourth thin film transistor (T4); wherein a gate of the first thin film transistor (T1) is electrically connected to first scan lines, a source thereof is electrically connected to the data lines, a drain thereof is electrically connected to a gate of the second thin film transistor (T2) and an end of the first capacitor, and another end of the first capacitor is grounded; wherein the gate of the second thin film transistor (T2) is electrically connected to the drain of the first thin film transistor (T1), a source thereof is grounded, and a drain thereof is electrically connected to a cathode of an organic light emitting diode and a drain of the third thin film transistor (T3); wherein a gate of the third thin film transistor (T3) is electrically connected to a drain of the fourth thin film transistor (T4) and an end of the second capacitor, the drain thereof is electrically connected to the drain of the second thin film transistor (T2) and the cathode of the organic light emitting diode, a source thereof is grounded, and another end of the second capacitor is grounded; and wherein a gate of the fourth thin film transistor (T4) is electrically connected to second scan lines, a source thereof is electrically connected to the data lines, and the drain thereof is electrically connected to the gate of the third thin film transistor (T3) and an end of the second capacitor.

In an embodiment of the present disclosure, a capacitance value of the first capacitor is the same as a capacitance value of the second capacitor.

In an embodiment of the present disclosure, the first thin film transistor (T1), the second thin film transistor (T2), the third thin film transistor (T3), and the fourth thin film transistors (T4) are all N-type thin film transistors.

In an embodiment of the present disclosure, the first thin film transistor (T1), the second thin film transistor (T2), the third thin film transistor (T3), and the fourth thin film transistor (T4) each comprise an oxide thin film transistor or an amorphous silicon thin film transistor.

In an embodiment of the present disclosure, the first thin film transistor (T1), the second thin film transistor (T2), the third thin film transistor (T3), and the fourth thin film transistors (T4) are all top-gate thin film transistors.

In an embodiment of the present disclosure, a plurality of driving cycles of the driving circuit unit are the same.

According to a third aspect of an embodiment of the present disclosure, a driving method of a driving circuit of a display panel is provided, comprising: providing a first control signal and a second control signal that appear periodically by data lines; during a first control signal period, a first driving circuit unit in a driving circuit unit operating and driving a light emitting diode to emit light; and during a second control signal period, stopping the first driving circuit unit in the driving circuit unit, and a second driving circuit unit operating and driving the light emitting diode to emit light.

In an embodiment of the present disclosure, a control time of the first control signal and a control time of the second control signal are the same.

In an embodiment of the present disclosure, the control time of the first control signal and the control time of the second control signal are both less than 15 ms.

In an embodiment of the present disclosure, the control time of the first control signal and the control time of the second control signal are both 10 ms.

In an embodiment of the present disclosure, the first driving circuit unit and the second driving circuit unit are periodically and alternately driven to operate to power the light emitting diode.

Beneficial effects of the present application are that: an embodiment of the present disclosure provides a driving circuit and a driving method of a display panel. After a thin film transistor in the driving circuit operates continuously for a long time, heat is continuously accumulated and stability of the circuit is reduced. An embodiment of the present disclosure provides a plurality of driving circuit units, and separately controls operating time of the plurality of driving circuit units. Multiple driving circuit units operate alternately and periodically. Each driving circuit unit stops driving after driving a light emitting diode for a certain period of time. Operation of a next driving circuit unit is controlled, such that a next driving circuit unit drives the light emitting diode to operate. This prevents the thin film transistor in each driving circuit unit from accumulating heat during operating hours. This solves issues of heat generation in the driving circuit and improves a display performance of the display panel.

### DESCRIPTION OF DRAWINGS

FIG. 1 is a schematic diagram of a driving circuit of a display panel according to an embodiment of the disclosure.

FIG. 2 is a schematic diagram of a driving circuit according to an embodiment of the present disclosure.

### DETAILED DESCRIPTION OF PREFERRED EMBODIMENTS

The following descriptions of the embodiments are made with reference to additional drawings to illustrate specific embodiments that the present disclosure can be implemented.

In a micro light emitting diode liquid crystal display panel, in order to reduce production costs, a MOS transistor device is often not designed in a driving circuit thereof. A common driving circuit structure comprises two thin film transistors and a capacitive structure, and is connected to gate lines and data lines to provide a driving voltage. However, in this structure, when a panel is operated for a long time, the thin film transistors in the driving circuit needs to be continuously operated for a long time. During operation of the thin film transistors, due to accumulation of thermal effects, a temperature inside the thin film transistors rises, which affects stability of the entire driving circuit and causes a display performance of the panel to decrease.

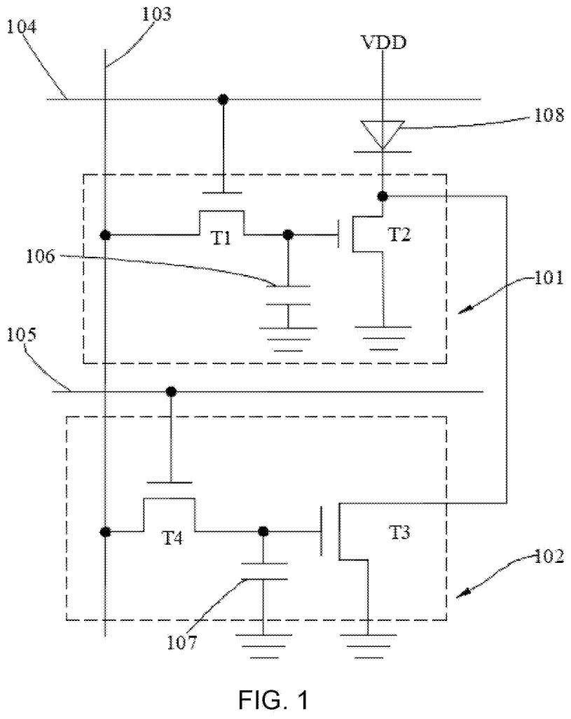

In an embodiment of the present disclosure, an embodiment of the present disclosure provides a driving circuit structure of a display panel to solve issues of thermal effects of thin film transistors in a driving circuit. As shown in FIG. 1, FIG. 1 is a schematic diagram of a driving circuit of a display panel according to an embodiment of the present disclosure. The driving circuit includes a plurality of driving circuit units. In this embodiment, a driving circuit unit 101 and a driving circuit unit 102 are taken as examples for description.

The driving circuit includes data lines 103, first scan lines 104, and second scan lines 105. The data lines 103 provide a data signal to control a thin film transistor device in the driving circuit to be turned on or off.

Specifically, the driving circuit unit 101 includes a first thin film transistor T1, a second thin film transistor T2, and a first capacitor 106. A gate of the first thin film transistor T1 is electrically connected to first scan lines 104, and a source of the first thin film transistor T1 is electrically connected to data lines 103. In addition, a drain of the first thin film transistor T1 is electrically connected to a gate of the second thin film transistor T2 and an end of the first capacitor 106, and another end of the first capacitor 106 is grounded.

For the second thin film transistor T2, a gate of the second thin film transistor T2 is electrically connected to the drain of the first thin film crystal T1, and a source of the second thin film transistor T2 is grounded. In addition, a drain of the second thin film transistor T2 is electrically connected to a cathode of an organic light emitting diode 108 and a drain of the third thin film transistor T3. In addition, an anode of the organic light emitting diode 108 is connected to a power supply voltage, which may be a DC voltage.

When the driving circuit unit 101 operates, let n be a positive integer, and during a display time of a nth frame image, the first scan lines 104 provides a scan signal line by line. At the same time, the data lines 103 provide a first control signal. Data control signal enters the gate of the second thin film transistor T2 and the first capacitor 106 through the first thin film transistor T1 and is stored in the first capacitor 106. This keeps the second thin film transistor T2 in an on state, and a current is formed and flows through the organic light emitting diode 108. This causes the organic light emitting diode 108 to be turned on and emit light, thereby driving the driving circuit unit 101.

Further, the driving circuit unit 102 includes a third thin film transistor T3, a fourth thin film transistor T4, and a second capacitor 107. A gate of the third thin film transistor T3 is electrically connected to a drain of the fourth thin film transistor and an end of the second capacitor 107. A drain of the third thin film transistor T3 is electrically connected to the drain of the second thin film transistor T2 and a cathode of the organic light emitting diode 108. At the same time, a source of the third thin film transistor T3 is grounded, and another end of the second capacitor 107 is grounded.

For the fourth thin film transistor T4, a gate of the fourth thin film transistor T4 is electrically connected to second scan lines 105, and a source of the fourth thin film transistor T4 is electrically connected to the data lines 103. At the same time, a drain of the fourth thin film transistor T4 is electrically connected to the gate of the third thin film transistor T3 and an end of the second capacitor 107.

When the driving circuit unit 102 operates, a driving chip controls data control signal of the data lines through a driving algorithm within a display time of a n+1th frame image. The second scan lines 105 provide a scan signal line by line. At the same time, the data lines 103 provide a second control signal. The data control signal enters the gate of the third thin film transistor T3 and the second capacitor 107 through the fourth thin film crystal T4, and is stored in the second capacitor 107. This keeps the third thin film transistor T3 in an on state, thereby forming a current. The drain of the third thin film transistor T3 is connected to the organic light emitting diode 108 when the driving circuit unit 102 operates. Therefore, the turned-on circuit flows through the organic light emitting diode 108 and causes it to emit light, thereby realizing the driving of the driving circuit unit 102.

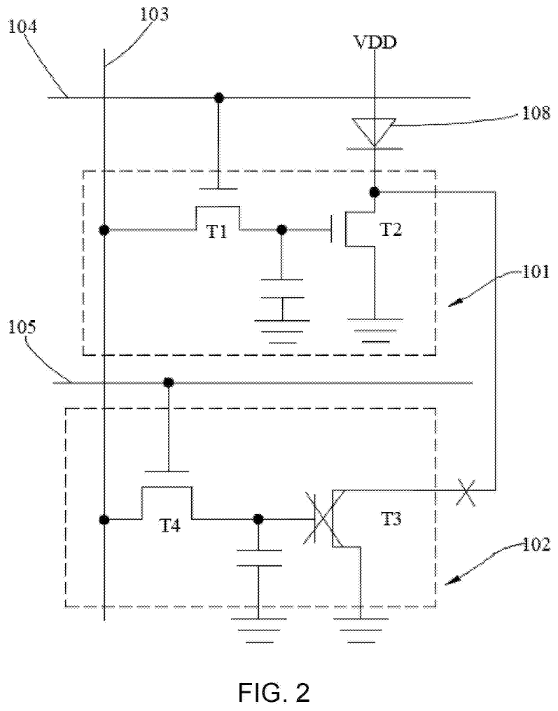

In an embodiment of the present disclosure, by controlling the control signals of the driving chip and the data signals of the data lines in the display panel, that is, the first control signal and the second control signal, the driving circuit unit 101 and the driving circuit unit 102 are not operated at the same time. As shown in FIG. 2, FIG. 2 is a schematic diagram of a driving circuit according to an embodiment of the present disclosure. The operation timing of the driving circuit unit 101 is set to t1. During the time period t1, the data lines 103 provide the first control signal and the first scan lines 104 provide the scan signal, so that the driving circuit unit 101 operates normally. Specifically, the light emitting diode 108 and the second thin film transistor T2 are turned on. The light emitting diode 108 does not conduct with the third thin film transistor T3. The second thin film transistor T2 operates normally. Correspondingly, as shown in FIG. 2, the third thin film transistor T3 is in an off state, and the light emitting diode 108 emits light.

When the time t1 ends and the time period t2 is reached, the data lines 103 start to provide a second control signal, the second thin film transistor T2 is turned off, the organic light emitting diode 108 and the second thin film transistor T2 are not conductive, and conduction is formed between the organic light emitting diode 108 and the third thin film transistor T3. At this time, the driving circuit unit 102 is normally driven and the driving circuit unit 101 is not driven.

Therefore, the first driving circuit unit 101 and the second driving circuit unit 102 are alternately and periodically driven. During the time period of t1, the first driving circuit unit 101 is normally driven and the second driving circuit unit 102 is not driven. During the time period of t2, the first driving circuit unit 101 is not driven, and the second driving circuit unit 102 is normally driven to operate. Due to the short duration of the time periods t1 and t2, the heat accumulated by the thin film transistors in each driving circuit unit during the time period is not enough to affect itself. This cannot cause the thin film transistor to generate electrical drift due to self-heating, thereby effectively solving issues of thin film transistor device heating and low stability. In the embodiment of the present disclosure, the time period of the time period t1 and the time period of the time period t2 may be the same or different, and are set according to the specific parameters of the actual product.

In an embodiment of the present disclosure, preferably, t1=t2=10 ms, that is, conduction between each of the first driving circuit unit 101 and the second driving circuit unit 102 and the organic light emitting diode is 10 ms, and then conversion driving is performed. A duty cycle thereof is T=10 ms. Preferably, in order to avoid that spontaneous heat accumulation of the thin film transistor during the operating time period causes a device drift threshold to be exceeded, its conversion period T is less than 15 ms.

Meanwhile, the thin film transistors in one embodiment of the present disclosure may be N-type thin film transistors, and the N-type thin film transistors may include oxide thin film transistors or amorphous silicon thin film transistors. The thin film transistors may also be top gate thin film transistors. At the same time, a capacitance value of the capacitor in each driving circuit unit can be the same to ensure that when the organic light emitting diode emits light, light emission brightness and display performance are same in different periods. The above driving circuit unit may further include a plurality of periodic conversions of the plurality of driving circuit units to drive the organic light emitting diode to operate and emit light, thereby solving issues of heat accumulation of the thin film transistors during operation.

Further, an embodiment of the present disclosure also uses a driving method of a driving circuit. By periodically switching the driving circuit units, different driving circuit units provide currents and signals to the organic light emitting diode in different cycles. Specifically, the first control signal and the second control signal that are periodically changed are provided by the data lines. During the first control signal period, the first driving circuit unit of the driving circuit unit is operated, and the light emitting diode is driven to emit light normally. During the second control signal period, the first driving circuit unit is not driven, and the second driving unit starts to drive and is conductive with the organic light emitting diode, so that the organic light emitting diode emits light normally.

A driving circuit and a driving method of a display panel provided by embodiments of the present disclosure have been described in detail above. The descriptions of the above embodiments are only used to help understand technical solutions of the present disclosure and its core ideas. Those skilled in the art should understand that they can still modify the technical solutions described in the foregoing embodiments. These modifications or replacements do not deviate from the scope of the technical solutions of the embodiments of the present disclosure in the essence of the corresponding technical solutions.

What is claimed is:

1. A driving circuit of a display panel, comprising:
scan lines;
data lines;
a driving circuit unit, wherein the scan lines and the data lines are connected to the driving circuit unit, and the driving circuit unit comprises a first driving circuit unit and a second driving circuit unit; and
a light emitting diode, wherein a cathode of the light emitting diode is electrically connected to the driving circuit unit, and an anode of the light emitting diode is connected to a power supply voltage;
wherein when the driving circuit unit is driven, the first driving circuit unit and the second driving circuit unit are periodically and alternately driven to operate to power the light emitting diode;
wherein a driving cycle of the first driving circuit unit is the same as that of the second driving circuit unit, and each of the driving cycles is 10 ms.

2. The driving circuit of the display panel according to claim 1, wherein the first driving circuit unit comprises a first capacitor, a first thin film transistor (T1), and a second thin film transistor (T2), and the second driving circuit unit comprises a second capacitor, a third thin film transistor (T3), and a fourth thin film transistor (T4);
wherein a gate of the first thin film transistor (T1) is electrically connected to first scan lines, a source thereof is electrically connected to the data lines, a drain thereof is electrically connected to a gate of the second thin film transistor (T2) and an end of the first capacitor, and another end of the first capacitor is grounded;
wherein the gate of the second thin film transistor (T2) is electrically connected to the drain of the first thin film transistor (T1), a source thereof is grounded, and a drain thereof is electrically connected to a cathode of an organic light emitting diode and a drain of the third thin film transistor (T3);
wherein a gate of the third thin film transistor (T3) is electrically connected to a drain of the fourth thin film transistor (T4) and an end of the second capacitor, the drain thereof is electrically connected to the drain of the second thin film transistor (T2) and the cathode of the organic light emitting diode, a source thereof is grounded, and another end of the second capacitor is grounded; and
wherein a gate of the fourth thin film transistor (T4) is electrically connected to second scan lines, a source thereof is electrically connected to the data lines, and the drain thereof is electrically connected to the gate of the third thin film transistor (T3) and an end of the second capacitor.

3. The driving circuit of the display panel according to claim 2, wherein a capacitance value of the first capacitor is the same as a capacitance value of the second capacitor.

4. The driving circuit of the display panel according to claim 2, wherein the first thin film transistor (T1), the second thin film transistor (T2), the third thin film transistor (T3), and the fourth thin film transistors (T4) are all N-type thin film transistors.

5. The driving circuit of the display panel according to claim 2, wherein the first thin film transistor (T1), the second thin film transistor (T2), the third thin film transistor (T3), and the fourth thin film transistor (T4) each comprise an oxide thin film transistor or an amorphous silicon thin film transistor.

6. The driving circuit of the display panel according to claim 2, wherein the first thin film transistor (T1), the second thin film transistor (T2), the third thin film transistor (T3), and the fourth thin film transistors (T4) are all top-gate thin film transistors.

7. A driving circuit of a display panel, comprising:
scan lines;
data lines;
a driving circuit unit, wherein the scan lines and the data lines are connected to the driving circuit unit, and the driving circuit unit comprises a first driving circuit unit and a second driving circuit unit; and
a light emitting diode, wherein a cathode of the light emitting diode is electrically connected to the driving circuit unit, and an anode of the light emitting diode is connected to a power supply voltage;
wherein when the driving circuit unit is driven, the first driving circuit unit and the second driving circuit unit are periodically and alternately driven to operate to power the light emitting diode.

8. The driving circuit of the display panel according to claim 7, wherein the first driving circuit unit comprises a first capacitor, a first thin film transistor (T1), and a second thin film transistor (T2), and the second driving circuit unit comprises a second capacitor, a third thin film transistor (T3), and a fourth thin film transistor (T4);
wherein a gate of the first thin film transistor (T1) is electrically connected to first scan lines, a source thereof is electrically connected to the data lines, a drain thereof is electrically connected to a gate of the second thin film transistor (T2) and an end of the first capacitor, and another end of the first capacitor is grounded;
wherein the gate of the second thin film transistor (T2) is electrically connected to the drain of the first thin film transistor (T1), a source thereof is grounded, and a drain thereof is electrically connected to a cathode of an organic light emitting diode and a drain of the third thin film transistor (T3);
wherein a gate of the third thin film transistor (T3) is electrically connected to a drain of the fourth thin film transistor (T4) and an end of the second capacitor, the drain thereof is electrically connected to the drain of the second thin film transistor (T2) and the cathode of the organic light emitting diode, a source thereof is grounded, and another end of the second capacitor is grounded; and
wherein a gate of the fourth thin film transistor (T4) is electrically connected to second scan lines, a source thereof is electrically connected to the data lines, and the drain thereof is electrically connected to the gate of the third thin film transistor (T3) and an end of the second capacitor.

9. The driving circuit of the display panel according to claim 8, wherein a capacitance value of the first capacitor is the same as a capacitance value of the second capacitor.

10. The driving circuit of the display panel according to claim 8, wherein the first thin film transistor (T1), the second thin film transistor (T2), the third thin film transistor (T3), and the fourth thin film transistors (T4) are all N-type thin film transistors.

11. The driving circuit of the display panel according to claim 8, wherein the first thin film transistor (T1), the second thin film transistor (T2), the third thin film transistor (T3), and the fourth thin film transistor (T4) each comprise an oxide thin film transistor or an amorphous silicon thin film transistor.

12. The driving circuit of the display panel according to claim 8, wherein the first thin film transistor (T1), the second thin film transistor (T2), the third thin film transistor (T3), and the fourth thin film transistors (T4) are all top-gate thin film transistors.

13. The driving circuit of the display panel according to claim 7, wherein a plurality of driving cycles of the driving circuit unit are the same.

14. A driving method of a driving circuit of a display panel, comprising:
providing a first control signal and a second control signal that appear periodically by data lines;
during a first control signal period, a first driving circuit unit in a driving circuit unit operating and driving a light emitting diode to emit light; and
during a second control signal period, stopping the first driving circuit unit in the driving circuit unit, and a second driving circuit unit operating and driving the light emitting diode to emit light.

15. The driving method of the driving circuit of the display panel according to claim 14, wherein a control time of the first control signal and a control time of the second control signal are the same.

16. The driving method of the driving circuit of the display panel according to claim 15, wherein the control time of the first control signal and the control time of the second control signal are both less than 15 ms.

17. The driving method of the driving circuit of the display panel according to claim 16, wherein the control time of the first control signal and the control time of the second control signal are both 10 ms.

18. The driving method of the driving circuit of the display panel according to claim 14, wherein the first driving circuit unit and the second driving circuit unit are periodically and alternately driven to operate to power the light emitting diode.
